(19) United States
(12) Patent Application Publication
(10) Pub. No.: US 2025/0328944 A1
(43) Pub. Date: Oct. 23, 2025

(54) SHARED CACHING SYSTEM FOR UNIFIED EXPERIMENTATIONS USING MACHINE-LEARNED MODELS

(71) Applicant: Maplebear Inc., San Francisco, CA (US)

(72) Inventors: Rustin Partow, San Francisco, CA (US); Levi Boxell, Brownsburg, IN (US); Khanh-Dan Tran-kiem, Oakland, CA (US); Luis Gardea, San Francisco, CA (US)

(21) Appl. No.: 18/641,198

(22) Filed: Apr. 19, 2024

(51) Int. Cl. G06Q 30/0601; G06Q 30/02; G06Q 30/0204; H04L 67/50

(52) U.S. Cl. CPC G06Q 30/0631; G06Q 30/0204; G06Q 30/0281; H04L 67/535

(57) ABSTRACT

An online system maintains a shared cache for storing actions assigned to users in different experiment groups. The system receives an indication that a user interacted with an online system, and data associated with the user. The system generates a set of propensities for a set of actions by identifying a first set of features for the user, accessing a first machine learning model, and applying the first machine learning model to the first set of features. The system selects an action based on the set of propensities and presents the action to the user. The system updates a cache of a set of user data and includes the transmitted action. The system receives a second indication and accesses a database to determine a selected action stored in association to the user. The system presents the selected action for a second time to the user.

### BACKGROUND

An online system evaluates a machine-learned policy model for assigning an action from a set of actions to a user. Current online systems utilize machine-learned contextual policies to predict what actions should be assigned to a user such that, for example, the user would engage with the online system. Typically, the online system may perform experiments for different subgroups of users, with each experiment having its own set of components.

### SUMMARY

In one or more embodiments, an online system receives, from a new user, an indication the user interacted with an online system, and data associated with the new user. The online system generates a set of propensities for a set of actions for the new user. To generate the set of propensities for the set of actions, the online system identifies a first set of features for the user, accesses a first machine learning model, and applies the first machine learning model to the first set of features. The online system selects an action based on the set of propensities and presents the action to the new user. The online system updates a cache of a set of user data, where the user data includes the transmitted action. The online system receives a second indication that the user interacted with the online system for a second time. The online system accesses a database of a set of user data to determine whether a selected action is stored in association to the user. In response to determining the selected action that is stored in association to the user, the online system presents the selected action for a second time to the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example system environment for an experiment module, in accordance with one or more embodiments.

FIG. 4 illustrates a flowchart for an experiment module, in accordance with one or more embodiments.

### DETAILED DESCRIPTION

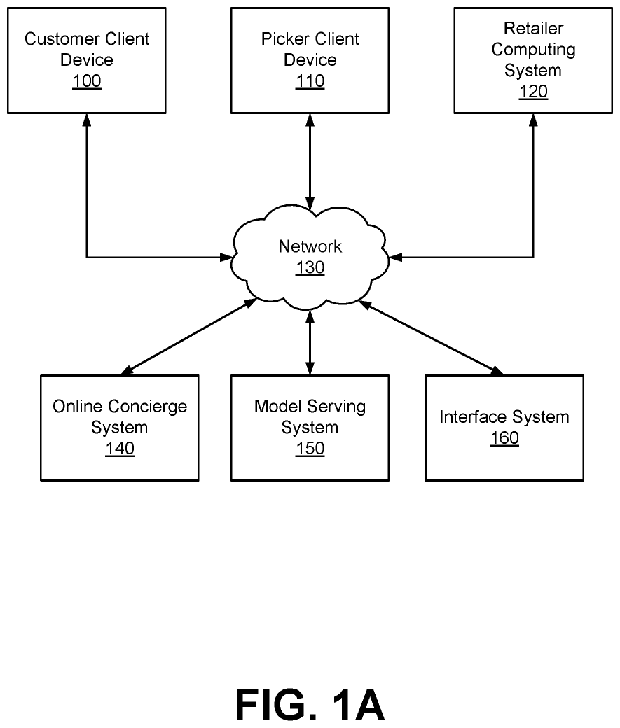

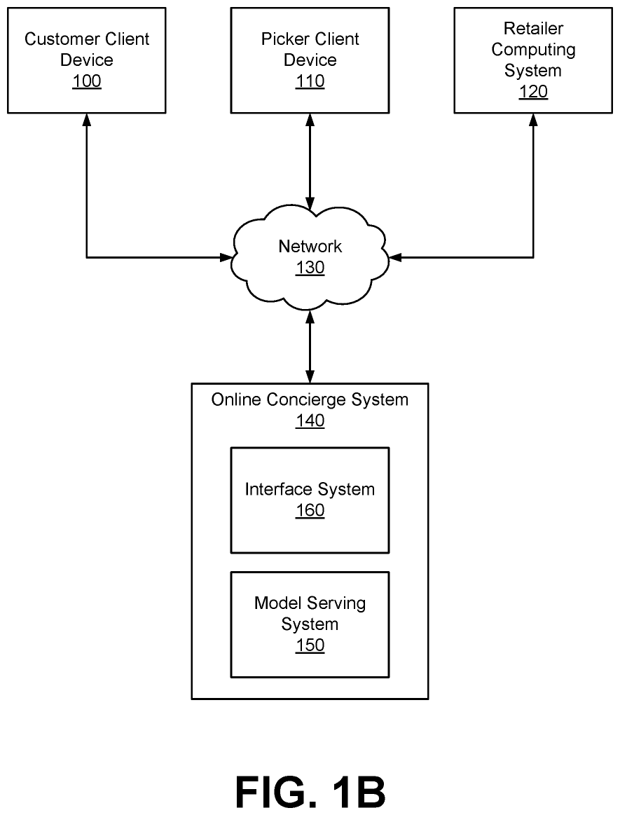

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140.

In one or more embodiments, the online system 140 performs experiments to test different actions to present to a user interacting with the application of the online system 140. The online system 140 determines different actions to present to eligible users in different user groups. The online system 140 describes a unified data structure including two separate models and a single cache system. The shared cache system between the two separate ML models simplifies the design and automatically respects the decisions made previously by one user group. Specifically, a policy is a set of decision rules prescribing a propensity for taking an action based on received inputs to the machine learning model. For example, a policy for a user may assign propensities, or likelihoods, that the system selects a respective action based on the user's extracted features.

An action for a user is an action performed by the online system 140 for the experiment. In one or more embodiments, a set of actions presented to a user often refer to a set of commands, controls, content items, or options presented to a user through a user interface. For example, a set of actions presented to the user is a set of digital subscription coupons presented to the digital platform of the user. As another example, a set of actions in an action space may be upselling an annual subscription with no discount to the user, upselling a monthly subscription, upselling an annual subscription with a $19 off discount to the user, and upselling an annual subscription with a $49 off discount.

In one or more embodiments, the online system 140 trains a policy machine-learned model to assign the user a set of propensities corresponding to a set of actions. A higher propensity corresponds to a higher likelihood that the system assigns the action associated with a higher propensity over that of another. However, different subgroups of users may behave differently and the online system 140 may train different models for each respective subgroup of users. For example, new users and users that are existing users (returning users) behave differently, and the online system 140 may train a policy model for the new user and a returning policy model for the existing user. Typically, each experiment may maintain its own separate components (e.g., cache memory, databases). Since a user may initially be assigned to one subgroup, and then assigned to another subgroup, it is challenging for the online system 140 to track the user as the user is assigned to different experiments, and/or has to maintain cross-component logic infrastructure.

In one or more embodiments, the online system 140 configures a shared cache that is accessible by both the experiment for new users and the experiment for existing users. The shared cache is described below in more detail in conjunction with 225, stores decisions made for users and when the user returns, the same action is presented if within a time-to-live (TTL) window. This way, the online system 140 automatically presents the action selected during the new user experiment when the user re-accesses the online system 140. Further, the shared cache simplifies the architecture of the online system 140 by removing cross-cache logic infrastructure within traditional unified architectural systems.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

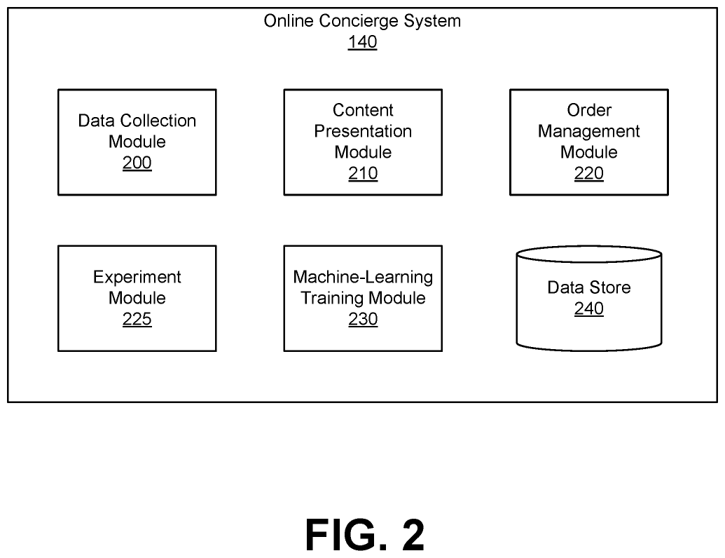

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The experiment module 225 applies machine-learned policy models to perform experiments that determine actions to present to users that will likely lead to high rewards for the online system 140. An experiment assigns an action to a user among one or more actions by applying a machine-learning model to features extracted for the user and the actions. In one or more embodiments, the online system 140 trains one or more policy machine-learned models to perform an experiment.

New users and existing users behave differently. By understanding how user behavior within a certain context differs, the experiment module 225 applies different policies to perform experiments to determine actions of a higher reward. Existing users include users who have previously interacted with the application of the online system 140 or logged into the application and have returned to the online system 140. New users include users who are interacting with the application for a first time. The engagement efforts of the online system 140 for existing users and new users thus differ. Therefore, the online system 140 performs two different experiments, one for new users and one for existing users. The experiment for new users applies a new user ML model and the experiment for existing users applies an existing user ML model.

The experiment module 225 configures a A/B assignment process for a set of eligible users where once a user is assigned to the unified data system experiment, the user can be assigned to a new user experiment or an existing user experiment depending on whether the user is a new user or an existing user. The new user experiment is performed using a new user model. The new user ML model receives a set of features from the user and outputs a first set of propensities for a set of actions. The input features include user contextual data. The existing user experiment is performed using an existing user ML model. The existing user ML model receives a set of features from the user and outputs a second set of propensities for a set of actions. In one or more embodiments, the number of features extracted for the existing user model is higher than that of the new user model. Specifically, because more information may be known about existing users, the number of features available for an existing user is higher than the number of features available for a new user. For example, the features for an existing user may be obtained from previous feedback obtained from the user based on the presented actions, and the like.

The contextual data including, but not limited to, the browsing history of the user during the order session, attributes of the user, and other types of contextual data about the user as collected by the data collection module 200 in the prompt. For example, the browsing history of the user may include an ordered list of websites or pages the customer visited during the ordering session. The contextual information provides additional context for determining the action to present to the user.

In one or more embodiments, the online system 140 includes a single cache data structure shared by the two experiments. The online system 140 also configures a cache that is a cache system within the unified system. In one instance, it is a horizontally scalable datastore and as described below in more detail. The cache is used to store user data identifying a user and a selected action for the user that was obtained during a previous run of the experiment for the user. In one instance, the shared cache is a persistent cache rather than an in-memory store. For a new user group, the online system 140 assigns and indexes a user identifier wherein the online system 140 stores the user's information when accessing the online system 140, and the action selected for the new user. In one instance, the cache is configured to automatically delete entries that are outside a given TTL window (e.g., 30 days, 60 days, 90 days).

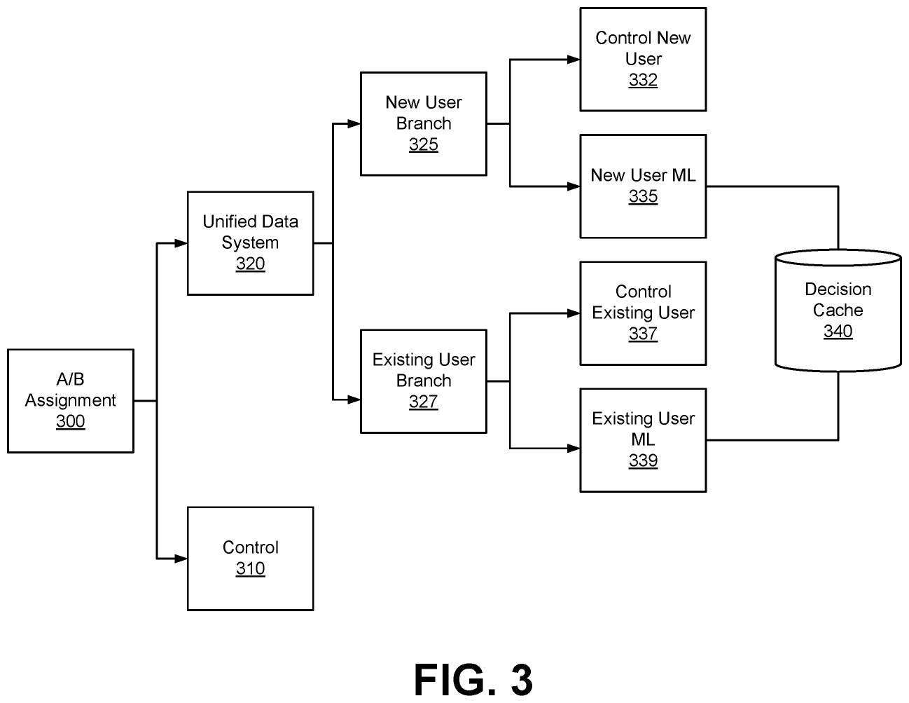

FIG. 3 illustrates a process for performing a new user experiment and an existing user experiment, in accordance with one or more embodiments. For an eligible user, FIG. 3 describes a A/B experiment assignment system 300 for a first subset and a second subset of eligible users. A first subset of the eligible users is assigned to a unified data structure to perform experiments to determine a selected action for the user. A second subset of the eligible users is assigned to a control action 310 (e.g., no trial or no action). In one instance, the control 310 is to maintain the previously determined action to the eligible user.

From the first subset of the eligible users, the unified data system 320 assigns a first subset of eligible users in the unified data system to a new user branch 325. The new user branch assigns a first subset of the new users the control action 332 and a second subset of the new users to a New User Model 335. The unified data system 320 assigns a second subset of eligible users in the unified data system to an existing user branch 327. The existing user branch 327 assigns a first subset of the existing users the control action 337 and a second subset of the existing users to an Existing User ML 339. Both experiments update and access a shared decision cache 340 when accessing and indexing user information for the ML model.

The experiment module 225 accesses the shared decision cache 340 to determine if a user has a selected action that was previously assigned to the user within the TTL window stored in the cache 340. If a decision associated with the user is stored, the user is assigned the same action (e.g., upsell annual subscription, no discount) as the stored decision. Otherwise, if no decision associated with the user is stored, the experiment module 225 enters the user into a experiment assignment process that involves a unified new user experiment and a unified existing user experiment. In one instance, the user is selected to the unified data system experiment or a control (e.g., business-as-usual) 310 with a 50% and 50% probability. The control 310 may be pre-determined to select the action to present to the user (e.g., maintain the action of a previous action, select a control action).

The experiment module 225 determines whether the user is a new user or an existing user. The experiment module 225 receives user identifiers that describe whether a user has at least interacted or associated with the online system 140. A new user is a user that has not interacted with the online system 140. The online system 140 creates and stores a first user identifier that the user has associated and interacted with the online system 140. A returning or existing user is a user that the online system 140 stores with at least a user identifier, as an indication of previously interacting with the online system.

If the user is a new user, the experiment module 225 may assign a control 332 for the new user. The control 332 for new users may be to present no discount to the user. The experiment module 225 may assign a New User ML model 335 to determine a first action to present to the user. The New User ML model 335 receives a set of features for the user (e.g., user contextual data, and user identifier data) and outputs a first set of propensities for a set of actions. The New User ML model 335 determines a set of propensities for a new user.

As an example, the New User ML model receives contextual data such as browsing data and calculates the propensities for an action subspace. For a set of actions, an action space may be upselling annual subscription with no discount, upselling a monthly subscription, upselling an annual subscription with a discount $19 off, and upselling an annual subscription with a discount $49 off. The New User ML model generates propensities for each action. The online system 140 then randomly selects a single action using the ML-generated propensities to determine the probability that each action is selected by the system. The experiment module 225 writes a user identifier for the user and the action selected for the user to the DDB cache. The experiment module 225 may additionally write whether the user positively interacts with the selected action to the cache 340. In one instance, the inference using the New User ML 335 is made by invoking an API call to an endpoint hosting the machine-learned model.

If the user is an existing user, the experiment module 225 may assign a control 332 for the existing user. The experiment module 225 may also assign the user to the Existing User ML model 339. The Existing User ML model receives a set of features from the user (e.g., user contextual data, and user identifier data, and previous selected actions of the user) and outputs a set of propensities for a set of actions.

As an example, the Existing User ML model 339 receives contextual data such as browsing data, training data and calculates the propensity for an action subspace. The Existing User ML model generates a set of propensities for the action subspace. The online system 140 randomly selects the action assigned to the user according to the determined propensity for the action. In one or more embodiments, the action space of the New User ML 335 and the Existing User ML 339 may overlap or be the same action space that encodes the same set of actions. The experiment module 225 accesses the shared decision cache 340 to index and update the user identifier for the user and the action selected for the user.

In one or more embodiments, the experiment module 225 may pre-compute the propensities of a set of existing users and store the propensities for the set of actions in a table in a database. Since the number of features for existing users is large, computing the propensities real-time may result in higher latency. Therefore, in one or more embodiments, the propensities for the set of existing users are pre-computed by applying the Existing User ML 339 before a user enters the experiment and are stored in the data table. In one instance, the inference process is a batch inference process. When a decision must be made for an existing user (i.e., propensities for the user have to be determined based on Existing User ML 339), the experiment module 225 makes an Remote Procedure Call RPC or an API call to the database storing the propensities and retrieves the propensities for the user, selects an action based on the propensity values.

After the experiments are performed for a plurality of users, the rewards or responses to the transmitted actions (e.g., coupons, upsell opportunities) are collected. The collected data can be used as training data to re-train the New User ML 335 or the Existing User ML 339, or even train a new contextual policy model.

The shared cache between the New User ML model and the Existing User ML model simplifies the unified data system architecture when determining the propensities of an action presented to the user. By simplifying the architecture of the database, the database architecture reduces complexity within the caching layer which can lead to easier maintenance, troubleshooting, and scalability of the online system 140. Further, the single cache eliminates cross-cache logic infrastructure in traditional systems of separate caches for the separate ML models. This simplification leads to resource optimization and greater consistencies within the database architecture.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

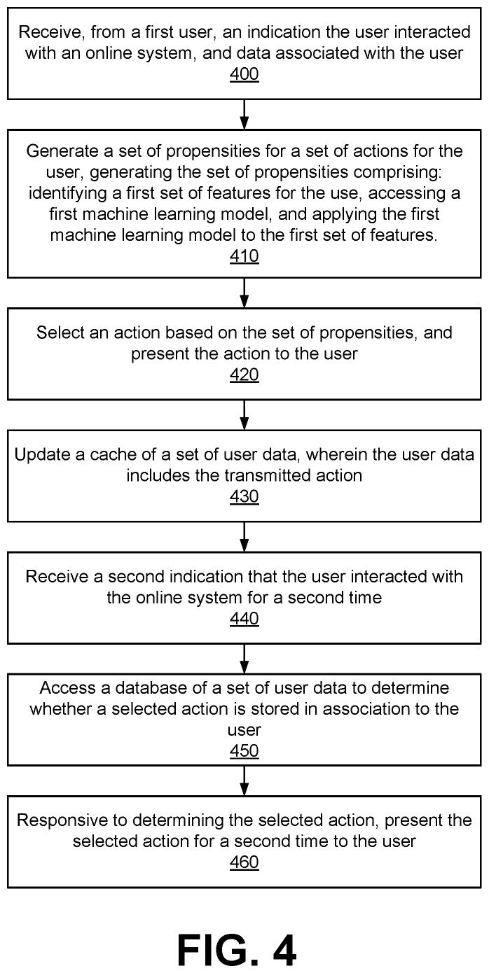

FIG. 4 is a flowchart for a method of an experiment module 225 in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention. An experiment module receives 400 from a user, an indication the user interacted with an online system, and data associated with the user. The module generates 410 a set of propensities for a set of actions for the user, generating the set of propensities to identify a first set of features for the user, access a first machine learning model, and apply the first machine learning model to the first set of features. The module selects 420 an action based on the set of propensities and presents the action to the user. The experiment module updates 430 a cache of a set of user data, wherein the user data includes the transmitted action. The experiment module receives 440 a second indication that the user interacted with the online system for a second time. The module accesses 450 a database of a set of user data to determine whether a selected action is stored in association to the user. Responsive 460 to determining the selected action, the experiment module presents the selected action for a second time to the user. If an action is not stored or the stored action has expired TTL, the propensities are generated and the propensities are stored.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, for a user, an indication the user interacted with an application of an online system, and obtaining data associated with the user where the data comprises contextual data and transactional data;
generating a set of propensities for a set of actions for the user, generating the set of propensities comprising:
identifying a first set of features for the user from the data associated with the user;
accessing a first machine-learned policy model, and;
applying the first machine-learned policy model to the first set of features to generate the set of propensities;
selecting an action based on the set of propensities;
presenting the action to the user;
updating a cache of a set of user data wherein the user data includes the transmitted recommendation for the user;
receiving, a second indication the user interacted with the application for another time;
accessing a database of a set of user data for the user to determine whether a selected action is stored in association with the user; and
responsive to identifying that there is the selected action, presenting the selected action for a second time to the user.

2. The method of claim 1, wherein the indication the user interacted with an application of the online system is an indication the user opened or logged into an application of the online system.

3. The method of claim 1, wherein identifying the first set of features for the user, further comprises obtaining one or more of:
browsing history of the user during an order session,
attributes of the user, or
profile information of the user.

4. The method of claim 1, further comprising:
receiving a third indication the user interacted with the application at time greater than a predetermined window;
generating a second set of propensities for the set of actions for the user, generating the set of propensities comprising:
identifying a second set of features for the user,
accessing a second machine-learned policy model; and
applying the second machine-learned policy model to the second set of features to generate a second set of propensities;
selecting an action based on the second set of propensities;
presenting the action to the user; and
updating the cache to include the transmitted recommendation for the user.

5. The method of claim 4, wherein the method further comprises:
generating a training database of the user wherein the data includes the transmitted recommendation for the user and the user response to the transmitted recommendation for the user.

6. The method of claim 4, wherein the second machine learning model has a different set of parameters or a different architecture from the first machine learning model.

7. The method of claim 4, wherein a number of the second set of features is higher than a number of the first set of features.

8. A non-transitory computer-readable storage medium storing instructions that when executed by a computer processor cause the computer processor to perform steps comprising:
receiving, for a user, an indication the user interacted with an application of an online system, and obtaining data associated with the user where the data comprises contextual data and transactional data;
generating a set of propensities for a set of actions for the user, generating the set of propensities comprising:
identifying a first set of features for the user from the data associated with the user;
accessing a first machine-learned policy model, and;
applying the first machine-learned policy model to the first set of features to generate the set of propensities;
selecting an action based on the set of propensities;
presenting the action to the user;
updating a cache of a set of user data wherein the user data includes the transmitted recommendation for the user;
receiving, a second indication the user interacted with the application for another time;
accessing a database of a set of user data for the user to determine whether a selected action is stored in association with the user; and
responsive to identifying that there is the selected action, presenting the selected action for a second time to the user.

9. The non-transitory computer-readable storage medium of claim 8, wherein the indication the user interacted with an application of the online system is an indication the user opened or logged into an application of the online system.

10. The non-transitory computer-readable storage medium of claim 8, wherein identifying the first set of features for the user, further comprises obtaining one or more of:
browsing history of the user during an order session,
attributes of the user, or
profile information of the user.

11. The non-transitory computer-readable storage medium of claim 8, further comprising:
receiving a third indication the user interacted with the application at time greater than a predetermined window;
generating a second set of propensities for the set of actions for the user, generating the set of propensities comprising:
identifying a second set of features for the user,
accessing a second machine-learned policy model; and
applying the second machine-learned policy model to the second set of features to generate a second set of propensities;
selecting an action based on the second set of propensities;
presenting the action to the user; and
updating the cache to include the transmitted recommendation for the user.

12. The non-transitory computer-readable storage medium of claim 11, wherein the method further comprises:
generating a training database of the user wherein the data includes the transmitted recommendation for the user and the user response to the transmitted recommendation for the user.

13. The non-transitory computer-readable storage medium of claim 11, wherein the second machine learning model has a different set of parameters or a different architecture from the first machine learning model.

14. The non-transitory computer-readable storage medium of claim 11, wherein a number of the second set of features is higher than a number of the first set of features.

15. A computer system, the computer system comprising:
a computer processor; and
a non-transitory computer-readable storage medium storing instructions that when executed by a computer processor cause the computer processor to perform steps comprising:
receiving, for a user, an indication the user interacted with an application of an online system, and data associated with the user where the data comprises contextual data and transactional data;
generating a set of propensities for a set of actions for the user, generating the set of propensities comprising:
identifying a first set of features for the user from the data associated with the user;
accessing a first machine-learned policy model, and;
applying the first machine-learned policy model to the first set of features to generate the set of propensities;
selecting an action based on the set of propensities;
presenting the action to the user;
updating a cache of a set of user data wherein the user data includes the transmitted recommendation for the user;
receiving, a second indication the user interacted with the application for another time;
accessing a database of a set of user data for the user to determine whether a selected action is stored in association with the user; and
responsive to identifying that there is the selected action, presenting the selected action for a second time to the user.

16. The computer system of claim 15, wherein the indication the user interacted with an application of the online system is an indication the user opened or logged into an application of the online system.

17. The computer system of claim 15, wherein identifying the first set of features for the user, further comprises obtaining one or more of:
browsing history of the user during an order session,
attributes of the user, or
profile information of the user.

18. The computer system of claim 15, further comprising:
receiving a third indication the user interacted with the application at time greater than a predetermined window;
generating a second set of propensities for the set of actions for the user, generating the set of propensities comprising:
identifying a second set of features for the user,
accessing a second machine-learned policy model; and
applying the second machine-learned policy model to the second set of features to generate a second set of propensities;
selecting an action based on the second set of propensities;
presenting the action to the user; and
updating the cache to include the transmitted recommendation for the user.

19. The computer system of claim 18, wherein the method further comprises:
generating a training database of the user wherein the data includes the transmitted recommendation for the user and the user response to the transmitted recommendation for the user.

20. The computer system of claim 18, wherein the second machine learning model has a different set of parameters or a different architecture from the first machine learning model.
